(19) United States
(12) Patent Application Publication
(10) Pub. No.: US 2004/0241075 A1
(43) Pub. Date: Dec. 2, 2004

(54) Silicon monoxide vapor deposition material and method for preparation thereof

(76) Inventor: Kazuo Nishioka, Hyogo (JP)

Correspondence Address: DARBY & DARBY P.C., P. O. BOX 5257, NEW YORK, NY, 10150-5257, US

(21) Appl. No.: 10/489,074

(22) PCT Filed: Sep. 13, 2002
(86) PCT No.: PCT/JP02/09472

(30) Foreign Application Priority Data
Sep. 17, 2001 (JP) 2001-281524

(51) Int. Cl. C01B 33/20

(52) U.S. Cl. 423/325

(57) ABSTRACT

A method is provided for preparing a silicon monoxide vapor deposition material where a mixture of a silicon powder and a silicon dioxide powder is heated and reacted in a raw material chamber under vacuum to generate a silicon monoxide gas, and silicon monoxide is precipitated on a precipitation substrate in a precipitation chamber provided above the raw material chamber. As the precipitation substrate, a cylindrical body is used where a circumference wall is inclined from the perpendicular by 1 to 45 degrees and the inner diameter of the upper end thereof is smaller than that of the lower end, and the precipitation is conducted under a vacuum of 7 Pa to 40 Pa. The method allows the preparation of a silicon monoxide vapor deposition material exhibiting a weight reduction rate in the rattler test (a rattler value) of 1.0% or less. the method provides reduced occurrences of the splash phenomenon during the formation of a silicon monoxide vapor deposition film.

### FIELD OF THE INVENTION

The present invention relates to a silicon monoxide vapor deposition material which is used to manufacture a silicon oxide vapor deposition film that has superior gas barrier properties as a packaging material for food products, medical products, drugs and the like, and a method for the preparation thereof.

### BACKGROUND OF THE INVENTION

In the field of food product packaging, it is necessary to prevent the deterioration of fats and proteins contained in the packaging, i. e., to suppress deterioration in the quality of the product because of oxidation that might be caused by oxygen, water vapor, aromatic gases and the like that pass through the packaging material.

Furthermore, in the case of medical products and drugs, there is even a greater need to further suppress degeneration or deterioration of the contents.

Accordingly, materials which have high gas barrier properties against oxygen, water vapor, aromatic gases and the like that cause deterioration of the contents are required as packaging materials for food products, medical products, drugs and the like.

Such packaging materials that have high gas barrier properties include vapor deposition films in which silicon oxides are deposited by vapor deposition on a macromolecular film. In particular, silicon monoxide vapor deposition films, which have superior gas barrier properties against oxygen, water vapor, aromatic gases and the like, have attracted attention.

In regard to the silicon monoxide vapor deposition material that is the raw material used to form such silicon monoxide vapor deposition films, a raw material comprising a mixture of powdered silicon and powdered silicon dioxide is sublimated in a vacuum atmosphere at a high temperature. The silicon monoxide gas that is produced by the resulting reaction is precipitated on a precipitation substrate and condensed, so that the vapor deposition material is produced. This manufacturing method is called a vacuum condensation method.

To make the silicon monoxide vapor deposition material by the by the vacuum condensation method requires an extensive manufacturing process. Therefore, the resultant material would be necessarily expensive. Furthermore, the composition of the material in the direction of thickness may not be uniform.

That is, a portion initially precipitated on the precipitation substrate may have a needle-form composition, and when this portion is formed into a film as a vapor deposition material on the surface of another film, a phenomenon of splash may extensively occur. This leads to defects such as pinholes and the like in the silicon monoxide vapor deposition film to deteriorate the resistance to permeation.

### SUMMARY OF THE INVENTION

It is an object of the present invention to provide a silicon monoxide vapor deposition material that can reduce or suppress splash when this material is formed as a film on the surface of another film (in a silicon monoxide vapor deposition material that is manufactured by the vacuum condensation method), and a method for the production thereof.

The present inventor conducted various studies concerning the properties and compositions of silicon monoxide vapor deposition materials that can suppress the occurrence of splash in the formation of a silicon monoxide vapor deposition film. As a result, the inventor discovered that the brittleness of the material itself has a great effect on the splash phenomenon. Furthermore, as a result of diligent research with reference to the brittleness of such materials that can reduce or suppress splash, the inventor applied the rattler test used for the evaluation of pressed powders to silicon monoxide vapor deposition materials, and discovered that the occurrence of splash can be suppressed when such materials have a specific rate of resistance to weight reduction (rattler value).

Furthermore, in an implementation of the present invention, the rattler value was measured by the method described in the standard “JPMA P11-1992 Metal Pressed Powder Rattler Value Measurement Method” of the Japanese Powder-Forged Metal Association (JPMA).

Furthermore, as a result of various studies concerning methods for producing a silicon monoxide vapor deposition material that has a specific rattler value, the present inventor discovered that the silicon monoxide vapor deposition material that has a specific rattler value can be stably obtained. The object of the present invention can be achieved by forming the inner circumferential surface of the cylindrical tube used as a substrate for precipitation and condensation during the rise of the vapor deposition material, which is heated and sublimated in a convention vacuum condensation process as a specified inclined inner circumferential surface, and precipitating and condensing the sublimated material on this inner circumferential surface. The internal diameter of the upper part of the cylindrical tube is smaller than the internal diameter of the lower part,

An implementation of the present invention relates to a silicon monoxide vapor deposition material produced by the vacuum condensation method. The vapor deposition material may have a rattler test weight reduction rate (rattler value) of 1.0% or less.

Furthermore, another implementation of the present invention relates to a method for producing a silicon monoxide vapor deposition material where a silicon monoxide vapor deposition material is obtained by condensing a vapor raw material produced by heating and sublimating a specified raw material on a tubular inner circumferential surface used as a precipitation substrate. The precipitation substrate, the inner circumferential wall of the tube ormed as an inclined inner circumferential surface, is inclined, for example, by 1 to 45 degrees with respect to a vertical line so that the upper part of the tubular body has a reduced diameter.

### BRIEF DESCRIPTION OF THE DRAWINGS

FIG. 1 illustrates a diagram of one example of the manufacturing apparatus used in the method of the present invention for producing a silicon monoxide vapor deposition material.

### DETAILED DESCRIPTION OF THE INVENTION

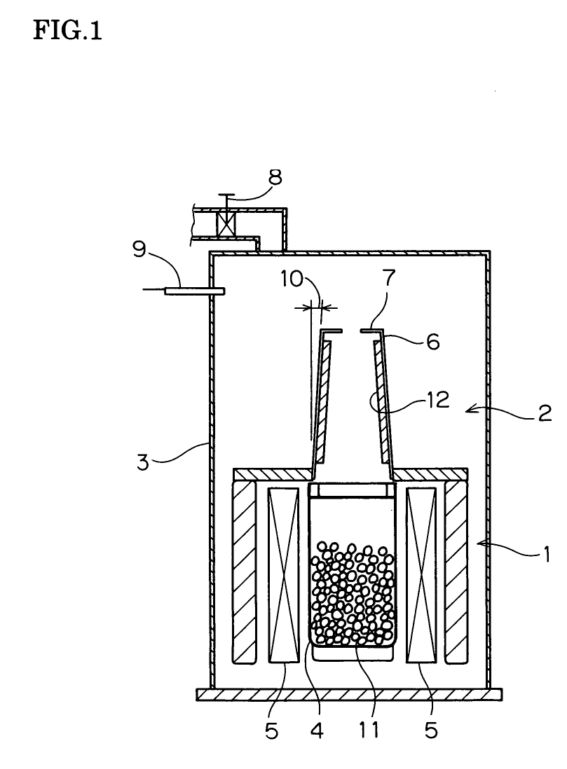

An embodiment of the method of the present invention for producing a silicon monoxide vapor deposition material will be described in detail in reference to an exemplarly manufacturing apparatus shown in FIG. 1. This apparatus has a construction in which a precipitation chamber 2 is mounted on top of a raw material chamber 1, and the apparatus is disposed inside a vacuum chamber 3.

Here, the raw material chamber 1 contains a cylindrical body; a raw material vessel 4 which includes a cylindrical tube with a bottom is inserted and disposed in the center of this raw material chamber 1. A heating source 5 containing, for example, an electric heater is disposed around this raw material chamber 1. The silicon monoxide gas produced by a process of sublimation and reaction caused by the heating source 5 rises from the open upper end of the raw material chamber 1. The precipitation chamber 2 is provided to precipitate the silicon monoxide gas that is sublimated in the raw material chamber 1. The sublimated gas component rises and passes through the interior of a precipitation substrate 6 that is disposed on the raw material vessel 4 of the raw material chamber 1 so that this substrate 6 communicates with the open upper end opening.

The precipitation substrate 6 includes a truncated conical tube or a truncated pyramidal tube made of stainless steel. Specifically, the precipitation substrate 6 has a shape such that the upper end side is constricted so that internal diameter of the upper end is smaller than the internal diameter of the lower end. The inner circumferential surface used to precipitate the sublimated silicon monoxide gas forms a surface inclined by a specified angle with respect to a vertical line. Furthermore, a lid 7 which has a hole opened in the center is installed so that this lid 7 can be freely attached to or removed from the upper end of the substrate.

One example of the precipitation substrate 6 was described above as an integral tubular body. However, the precipitation substrate need not necessarily be an integral type substrate. The substrate may be segmented into an arbitrary number of parts. Furthermore, the inner circumferential surface may not be completely inclined or be continuous in the circumferential direction. For example, a polygonal tube may have gaps between the adjacent inclined surfaces at the corner parts. In another example, a segmented tubular body can be used where its inclined inner circumferential surface may be disposed and supported inside by another ordinary tubular body.

In the present invention, the inner circumferential surface of the precipitation substrate 6 is formed as an inclined surface to obtain a high-quality silicon monoxide vapor deposition material that suppresses the occurrence of splash, i. e., a silicon monoxide vapor deposition material that has a rattler test weight reduction rate (rattler value) of 1.0% or less.

As a result of various experiments conducted by the present inventor, it was confirmed that the occurrence of splash can be suppressed by satisfying the rattler value requirement. Even for a one degree inclination, it is thought that the radiant heat on the precipitation substrate from the raw material chamber varies, so that a variation also occurs in the gas convection currents in the precipitation chamber and with the temperature distribution of the precipitation substrate. Thus, satisfying the rattler value requirement suppresses the occurrence of splash, though the exact reason for this effect is not clear.

Furthermore, if the inclination angle exceeds 45 degrees, the frequency with which the silicon monoxide precipitation layer peels from the precipitation substrate increases. Accordingly, to obtain a homogeneous silicon monoxide vapor deposition material with a uniform overall thickness, it is desirable to set the inclination of the precipitation substrate in the range of 1 degree to 45 degrees. A range of 2 degrees or greater, or 2 to 20 degrees, is even more desirable.

If the pressure inside the precipitation chamber 2 that is disposed inside the vacuum chamber 3 exceeds 40 Pa, the surface of the precipitated silicon monoxide precipitation layer will be formed as a surface with indentations and projections. Accordingly, such a high pressure is undesirable. On the other hand, if this pressure is less than 7 Pa, the fine and dense texture of the precipitation layer will drop. Accordingly, such a low pressure is also undesirable. The reason why the precipitation layer varies conspicuously according to pressure is unclear. However, at pressures outside the range of 7 Pa to 40 Pa, the rattler value is not reduced to 1.0 or less, so that the occurrence of splash cannot be sufficiently suppressed during the formation of the silicon monoxide vapor deposition film.

In the present invention, the pressure control means in the precipitation chamber 2 may be any control means or device. The pressure control may be simple control to mass flow control that controls the valve of the vacuum pump so that a specific pressure range is maintained in accordance with a vacuum gauge inside the chamber.

In the manufacturing apparatus using the vacuum condensation method of the present invention, any means or device may be used as the construction of the apparatus except that the precipitation substrate should have the shape of, for example, a truncated conical tube or truncated pyramidal tube (e. g., for the heating source). The vacuum chamber may be of any universally known construction.

### EMBODIMENTS

As the raw material placed in the raw material vessel 4 of the manufacturing apparatus shown in FIG. 1, powdered silicon (mean particle size 10 μm or less) obtained by mechanically pulverizing a semiconductor device silicon wafer, and commercially marketed powdered silicon dioxide (mean particle size 10 μm or less) were mixed in specified proportions This mixture was subjected to wet granulation using pure water, after which the granulated raw material was dried and used as a mixed raw material.

The mixed raw material 11 was paced into the raw material vessel 4 of the raw material chamber 1, and the vacuum chamber 3 was exhausted to a vacuum atmosphere at a pressure of 40 Pa, 25 Pa, 10 Pa or 7 Pa using the exhaust valve 8 of the vacuum chamber 3. Then, after the specified pressure was confirmed by the pressure gauge 9, power was supplied to the heating source 5 of the raw material chamber 1 so that the interior of the raw material chamber 1 was heated. A reaction was performed by maintaining the temperature at a specified temperature in the range of 1100 to 1350° C. for a specified time of approximately 1 hour or longer, thus producing a silicon monoxide gas.

The silicon monoxide gas thus produced rose from the raw material chamber 1 and entered the precipitation chamber 2. The gas was then precipitated on the inner circumferential wall of the precipitation substrate (inclined at an angle of 1 degree to 45 degrees), which was preheated to a temperature of 300 to 800° C. The silicon monoxide precipitation layer that was precipitated on the precipitation substrate 6 was uniformly precipitated at the same thickness over the entire substrate 6.

Furthermore, for purposes of comparison, a silicon monoxide gas was precipitated with the inclination of the precipitation substrate set at 60 degrees, 10 degrees or 0 degrees (conventional precipitation substrate) in a vacuum atmosphere at a pressure of 60 Pa, 40 Pa, 25 Pa or 5 Pa using the same mixed raw material as in the abovementioned embodiments of the present invention.

The weight reduction rate was measured by the rattler test for the respective silicon monoxide vapor deposition materials manufactured under the abovementioned conditions.

Furthermore, silicon monoxide vapor deposition films were manufactured by means of a resistance heating vapor deposition apparatus using the silicon monoxide vapor deposition materials thus obtained. Moreover, the conditions of splash generation during the formation of the silicon monoxide vapor deposition films were observed. The rattler values and conditions of splash generation are shown in Table 1.

It is seen from the results shown in Table 1 that Embodiments 1 through 13 of the present invention all showed a rattler value of 1.0 or less, and that there was little occurrence of splash during the formation of the silicon monoxide films. In particular, in embodiments in which the pressure was lowered to a value of 10 to 25 Pa, and the inclination of the precipitation substrate was set at 2 degrees or greater, even lower rattler values were obtained, and there was extremely little occurrence of splash during the formation of the silicon monoxide vapor deposition films.

On the other hand, Comparative Example 1 was a conventional embodiment in which a precipitation substrate with no inclination was used in the vacuum vapor deposition method. The rattler value was high, i. e., 2.0%, and extensive splash was seen during the formation of the silicon monoxide vapor deposition film.

Likewise, in the case of Comparative Example 2, in which the pressure was set at 60 Pa even though an inclined precipitation substrate was used, extensive splash was seen. In Comparative Examples 4 and 6, in which the condition of a pressure of 40 Pa or less was satisfied, but in which a precipitation substrate with an inclination of 60 degrees was used, the precipitated silicon monoxide precipitation layer peeled away, so that testing could not be performed. Furthermore, in the case of Comparative Example 5, in which a precipitation substrate with no inclination was used in a state where the pressure was low (25 Pa), the occurrence of splash was extensive, and in the case of Comparative Example 7, in which the pressure was lowered to 5 Pa while a precipitation substrate with an inclination of 10 degrees was used, the precipitation layer was brittle, and the occurrence of splash was extensive.

It is seen from the test results obtained for these comparative examples that the occurrence of splash during the formation of a silicon monoxide vapor deposition film can be suppressed if the inclination of the precipitation substrate is about 1 to 45 degrees, and (even more preferably) if the pressure inside the precipitation chamber is about 7 to 40 Pa.

TABLE 1

| | | Conditions of | | | |
|---|---|---|---|---|---|
| | | Precipitation | | | |
| | | | Inclination | Rattler | |
| | | Pressure | Angle | Value | Occurence of |
| | No. | (Pa) | (Degrees) | (%) | Splash |
| EM | 1 | 40 | 1 | 0.9 | little |
| | 2 | 40 | 2 | 0.8 | little |
| | 3 | 40 | 10 | 0.8 | little |
| | 4 | 40 | 20 | 0.8 | little |
| | 5 | 40 | 45 | 0.8 | little |
| | 6 | 25 | 1 | 0.8 | little |
| | 7 | 25 | 2 | 0.6 | extremely little |
| | 8 | 25 | 10 | 0.5 | extremely little |
| | 9 | 25 | 20 | 0.5 | extremely little |
| | 10 | 25 | 45 | 0.5 | extremely little |
| | 11 | 20 | 8 | 0.5 | extremely little |
| | 12 | 10 | 10 | 0.6 | extremely little |
| | 13 | 7 | 10 | 0.8 | little |
| CE | 1 | 60 | 0 | 2.0 | extensive |
| | 2 | 60 | 10 | 1.6 | extensive |
| | 3 | 40 | 0 | 1.3 | extensive |
| | 4 | 40 | 60 | — | — |
| | 5 | 25 | 0 | 1.1 | extensive |
| | 6 | 25 | 60 | — | — |
| | 7 | 5 | 10 | 1.2 | extensive |

[EM = EMBODIMENT]
[CE = Comparative Example]

The present invention makes it possible to obtain a silicon monoxide vapor deposition film which tends not to generate splash during film formation on another film, and which is superior in terms of resistance to permeation, by causing a silicon monoxide vapor deposition material produced by the vacuum condensation method to have a rattler test weight reduction rate (rattler value) of 1.0% or less.

In the present invention, the silicon monoxide vapor deposition material with a rattler value of 1.0% or less can be stably mass-produced by using a precipitation substrate that comprises an integral truncated conical tube or truncated pyramidal tube, or a segmented truncated conical tube or truncated pyramidal tube, during the manufacture of the silicon monoxide vapor deposition material by the vacuum condensation method.

In the present invention, a silicon monoxide vapor deposition material in which the rattler value is even smaller, and which shows conspicuously reduced splash during film formation, can be manufactured by controlling the pressure inside the precipitation substrate to a value of 7 Pa to 40 Pa during manufacture by the abovementioned vacuum condensation method.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite those features regarded as the invention.

1. A silicon monoxide vapor deposition material produced by the vacuum condensation method, comprising:
said material has a rattler test weight reduction rate (rattler value) of 1.0% or less.

2. A method for producing a silicon monoxide vapor deposition material, comprising:
providing a precipitation substrate comprising a tubular body whose inner circumferential wall is formed as an inclined surface so that the internal diameter on the side of the upper part of the tubular body is smaller than the internal diameter on the side of the lower part thereof; and
precipitating and condensing a vapor raw material, formed by heating and sublimating a raw material, on the inclined inner circumferential surface of the precipitation substrate to produce a silicon monoxide vapor deposition material.

3. The method for producing a silicon monoxide vapor deposition material according to claim 2, wherein the inner circumferential wall of the precipitation substrate in which the inner circumferential wall of the tube is formed as an inclined surface is segmented.

4. The method for producing a silicon monoxide vapor deposition material according to claim 2, wherein the atmosphere inside the precipitation substrate is a vacuum atmosphere at a pressure of 7 Pa to 40 Pa.

5. The method for producing a silicon monoxide vapor deposition material according to claim 2, wherein the inclined inner circumferential surface of the precipitation substrate is an inclined surface that is inclined by 1 to 45 degrees relative to a vertical line.

6. An apparatus for producing a silicon monoxide vapor deposition material, comprising:
a precipitation substrate comprising a tubular body whose inner circumferential wall is formed as an inclined surface so that the internal diameter on the side of the upper part of the tubular body is smaller than the internal diameter on the side of the lower part thereof,
wherein a vapor raw material, formed by heating and sublimating a raw material, is precipitated and condensed on the inclined inner circumferential surface of the precipitation substrate to produce a silicon monoxide vapor deposition material.

7. The apparatus for producing a silicon monoxide vapor deposition material according to claim 6, wherein the inner circumferential wall of the precipitation substrate in which the inner circumferential wall of the tube is formed as an inclined surface is segmented.

8. The apparatus for producing a silicon monoxide vapor deposition material according to claim 6, wherein the atmosphere inside the precipitation substrate is a vacuum atmosphere at a pressure of 7 Pa to 40 Pa.

9. The apparatus for producing a silicon monoxide vapor deposition material according to claim 6, wherein the inclined inner circumferential surface of the precipitation substrate is an inclined surface that is inclined by 1 to 45 degrees relative to a vertical line.
